(19) United States
(12) Patent Application Publication
(10) Pub. No.: US 2021/0150916 A1
(43) Pub. Date: May 20, 2021

(54) FLIGHT VEHICLE MANAGEMENT APPARATUS

(71) Applicant: NTT DOCOMO, INC., Tokyo (JP)

(72) Inventors: Takefumi YAMADA, Tokyo (JP); Youhei OONO, Tokyo (JP); Yuichiro SEGAWA, Tokyo (JP)

(73) Assignee: NTT DOCOMO, INC., Tokyo (JP)

(21) Appl. No.: 17/043,933

(22) PCT Filed: Mar. 25, 2019
(86) PCT No.: PCT/JP2019/012468

§ 371 Date: Sep. 30, 2020

(30) Foreign Application Priority Data
Apr. 5, 2018 (JP) 2018-073047

(51) Int. Cl. G08G 5/00; H04W 72/04; H04W 84/06

(52) U.S. Cl. CPC G08G 5/0043; G08G 5/0013; H04W 84/06; H04W 72/042; G08G 5/006

(57) ABSTRACT

An object of present invention is to suppress the case where communication performed between radio base station and radio communication apparatus of a flight vehicle is negatively influenced in an airspace in which interference occurs due to radio signals from radio base station. An assignment unit performs processing for, for each airspace, assigning a flight vehicle that has a radio communication apparatus that performs communication using at least a physical downlink channel. At this time, the assignment unit limits the assignment of flight vehicles to specified airspace in which the number of radio base stations for which a parameter specified by specification unit is in a predetermined first range that indicates good communication quality (e.g., number of radio base stations for which path loss of physical downlink channel to radio communication apparatus is less than or equal to threshold value) is greater than or equal to predetermined number (e.g., 2).

### TECHNICAL FIELD

The present invention relates to technology according to which an airspace for the flight of a flight vehicle is assigned to the flight vehicle.

### BACKGROUND

In order to achieve faster speeds than in Long Term Evolution (LTE), the 3rd Generation Partnership Project (3GPP) has created the LTE-Advanced (hereinafter, the term “LTE” includes LTE-Advanced) standard. The 3GPP is also reviewing specifications for a system called 5G (5th generation mobile communication system) or the like as a successor to LTE.

Under LTE, it is defined that the transmit power of a physical uplink channel is controlled based on the path loss between a radio base station (eNB) and a radio communication apparatus (UE). Specifically, it is defined that the transmit power of the physical uplink shared channel (specifically, PUSCH: Physical Uplink Shared Channel) is controlled based on the path loss of the physical downlink channel (e.g., see 1: 3GPP TS 36.213 V14.2.0 Subclause 5.1.1 Physical uplink shared channel, 3rd Generation Partnership Project; Technical Specification Group Radio Access Network; Evolved Universal Terrestrial Radio Access (E-UTRA); Physical layer procedures (Release 14).

There are also radio communication apparatuses (hereinafter called specified radio communication apparatuses) that carry out communication in the sky, where the line-of-sight is good in all directions, rather than on the ground, as with radio communication apparatuses provided in unmanned flight vehicles called drones.

With such a specified radio communication apparatus, the path loss of the physical downlink channel from the radio base station is small because the line-of-sight is good. In other words, the reception power of the physical downlink channel is high in the specified radio communication apparatus. Furthermore, one specified radio communication apparatus has a good line-of-sight to multiple radio base stations in the vicinity, and therefore the reception power of the physical downlink channel from each of the radio base stations is high, and a problem occurs in which the radio signals on the physical downlink channels from the radio base stations interfere with each other. As a result, there is a risk that communication between a radio base station and the radio communication apparatus of a flight vehicle that is connected to the radio base station will be negatively influenced.

### SUMMARY OF INVENTION

The present invention is achieved in light of the foregoing circumstances, and an object of the present invention is to suppress the case where communication performed between a radio base station and a radio communication apparatus of a flight vehicle is negatively influenced in an airspace in which interference occurs due to radio signals from the radio base station.

In one aspect, the present invention provides a flight vehicle management apparatus including: a specification unit configured to specify, for each airspace, a parameter regarding a communication quality of a radio communication apparatus in a cell formed by a radio base station; and an assignment unit configured to, for each airspace, assign a flight vehicle having a radio communication apparatus that performs communication using at least a physical downlink channel as a flight vehicle that is to fly in the airspace, and to limit assignment of a flight vehicle to an interference airspace, the interference airspace being an airspace in which the number of radio base stations for which the parameter specified by the specification unit is in a first range is greater than or equal to a predetermined number.

An aspect is possible in which in a case of a radio cell that is formed by, from among a group of radio base stations for which the parameter specified by specification unit is in the predetermined range, a radio base station that is not a radio base station connected to a radio communication apparatus provided in a flight vehicle, the assignment unit relaxes the limiting of assignment of a flight vehicle if the number of, or a communication load of, other radio communication apparatuses located in the radio cell is less than or equal to a threshold value.

An aspect is possible in which in a case of relaxing the limiting, the assignment unit assigns a larger number of flight vehicles to the interference airspace than in a case of not relaxing the limiting.

An aspect is possible in which in a case of relaxing the limiting, the assignment unit sets a smaller size for the interference airspace than in a case of not relaxing the limiting.

An aspect is possible in which in a case where a radio communication apparatus of a flight vehicle has little need to perform communication using a physical downlink channel, the assignment unit assigns the flight vehicle to the interference airspace.

According to the present invention, it is possible to suppress the case where communication performed between a radio base station and a radio communication apparatus of a flight vehicle is negatively influenced in an airspace in which interference occurs due to radio signals from the radio base station.

### BRIEF DESCRIPTION OF DRAWINGS

FIG. 1 is a block diagram showing an example of the configuration of flight control system 1, in accordance to the present invention

FIG. 2 is a block diagram showing the hardware configuration of radio communication apparatuses 20, in accordance to the present invention.

FIG. 3 is a block diagram showing the hardware configuration of flight vehicle management apparatus 50, in accordance to the present invention.

FIG. 4 is a diagram illustrating causes of interference, in accordance with the present invention.

FIG. 5 is a block diagram showing the functional configuration of flight vehicle management apparatus 50, in accordance to the present invention.

FIG. 6 is a flowchart showing an example of operations of flight vehicle management apparatus 50, in accordance to the present invention.

### DETAILED DESCRIPTION

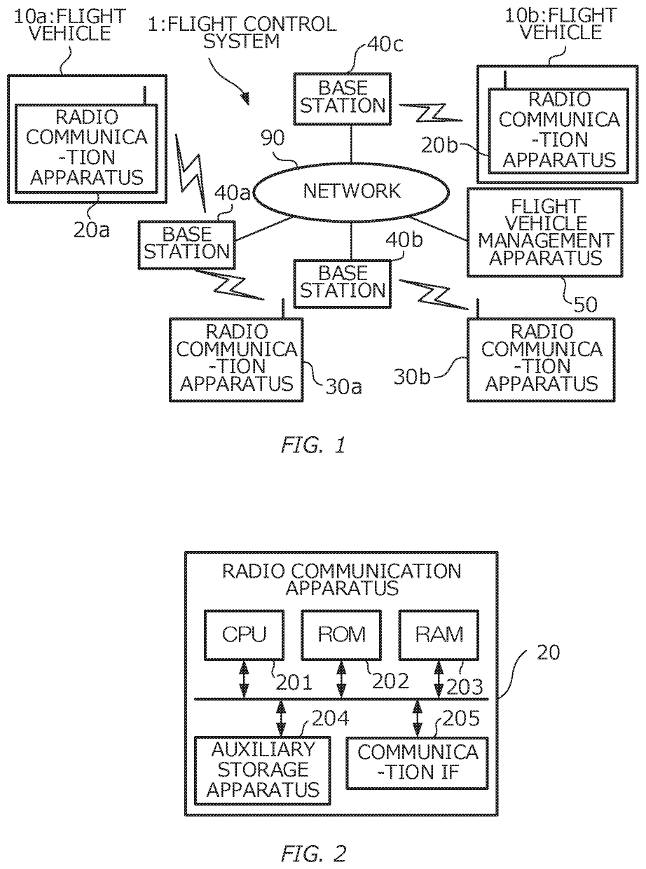

FIG. 1 is a diagram showing an example of the configuration of flight control system 1. Flight control system 1 includes multiple flight vehicles 10a and 10b that are drones or the like, multiple radio communication apparatuses 20a and 20b that are provided in flight vehicles 10a and 10b, multiple radio communication apparatuses 30a and 30b for use by users on the ground, network 90 that includes radio base stations 40a, 40b, and 40c, and flight vehicle management apparatus 50 that is connected to network 90. Note that hereinafter, flight vehicles 10a and 10b will be collectively called flight vehicles 10, radio communication apparatuses 20a and 20b will be collectively called radio communication apparatuses 20, radio communication apparatuses 30a and 30b will be collectively called radio communication apparatuses 30, and radio base stations 40a, 40b, and 40c will be collectively called radio base stations 40.

Each flight vehicle 10 physically includes a computer, various sensors controlled by the computer, and a drive mechanism that includes motors, rotor blades, and the like, and the computer includes a CPU (Central Processing Unit), a ROM (Read Only Memory), a RAM (Random Access Memory), and an auxiliary storage apparatus, as well as a positioning unit for measuring the position of the flight vehicle, a communication IF (Interface) for connection to radio communication apparatuses 20, and the like. Flight vehicle 10 flies in the air by the computer controlling the drive mechanism in accordance with a flight plan or the like that has been assigned to flight vehicle 10 and includes airspace positions, passage times for such positions, and the like. Note that flight vehicle 10 need only being a flying apparatus, and is also called a UAS (Unmanned Aircraft System), for example.

A radio communication system is constructed by network 90 that includes radio communication apparatuses 20 and 30 and radio base stations 40. This radio communication system is a radio communication system that complies with LTE (Long Term Evolution) standards, for example. In LTE, radio communication apparatuses 20 and 30 are called UEs, and radio base stations 40 are called eNBs. The areas where radio communication can be performed with radio base stations 40 are called cells. Radio communication apparatuses 20 and 30 that are located in (in the zone of) a cell perform radio communication with radio base station 40 that forms that cell. For example, radio communication apparatus 30 used by a user located on the ground executes radio communication with radio base station 40 located on the ground. On the other hand, radio communication apparatus 20 provided in flight vehicle 10 executes radio communication with radio base station 40 both when on the ground and when in the air (e.g., an airspace with an altitude of 30 m or more).

Flight vehicle management apparatus 50 is an information processing apparatus that controls and manages the flight of flight vehicles 10. In the present embodiment, flight vehicle management apparatus 50 particularly has a feature in processing for assigning flight airspaces to flight vehicles 10. This assignment of airspaces to flight vehicles 10 refers to processing in which flight vehicle management apparatus 50 stores identification information of flight vehicles 10 in correspondence with identification information of airspaces for the flight thereof as flight plans for corresponding flight vehicles 10. Note that functions in flight vehicle operation control are generally distributed among multiple systems such as an FIMS (Flight Information Management System) and a UASSP (UAS Service Provider), and flight vehicle management apparatus 50 of present embodiment may be implemented using such systems, or may be implemented using any one of such systems. Also, some of the functions of flight vehicle management apparatus 50, such as the functions of later-described specification unit (airspace communication state detection function), may be implanted using an apparatus other than a general FIMS or UASSP.

FIG. 2 is a block diagram showing the hardware configuration of radio communication apparatus 20. Radio communication apparatus 20 includes at least CPU 201 (Central Processing Unit), ROM (Read Only Memory) 202, RAM (Random Access Memory) 203, auxiliary storage apparatus 204, and communication IF 205. CPU 201 is a processor that performs various types of computation. ROM 202 is a non-volatile memory that stores a program and data used when radio communication apparatus 20 starts up, for example. RAM 203 is a volatile memory that functions as a work area for when CPU 201 executes programs. Auxiliary storage apparatus 204 is a non-volatile storage apparatus such as an HDD (Hard Disk Drive) or an SSD (Solid State Drive), and stores programs and data used in radio communication apparatus 20. Communication IF 205 is an interface for performing communication via network 90 in compliance with LTE. Note that besides the constituent elements illustrated in FIG. 2, radio communication apparatus 20 may include other constituent elements such as a display unit, an operation unit, or an audio input/output unit. Also, the hardware configuration of radio communication apparatus 30 is similar to that of radio communication apparatus 20, and therefore will not be described.

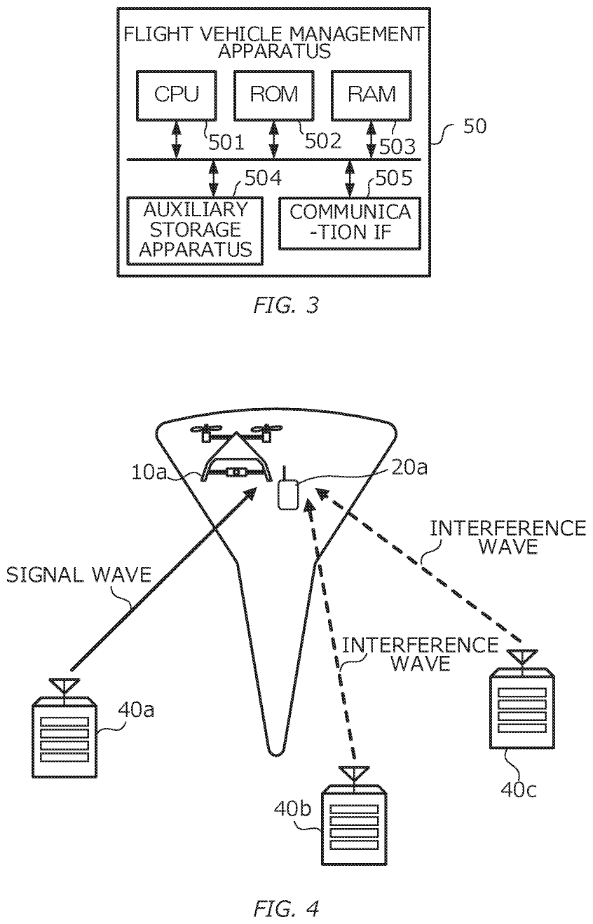

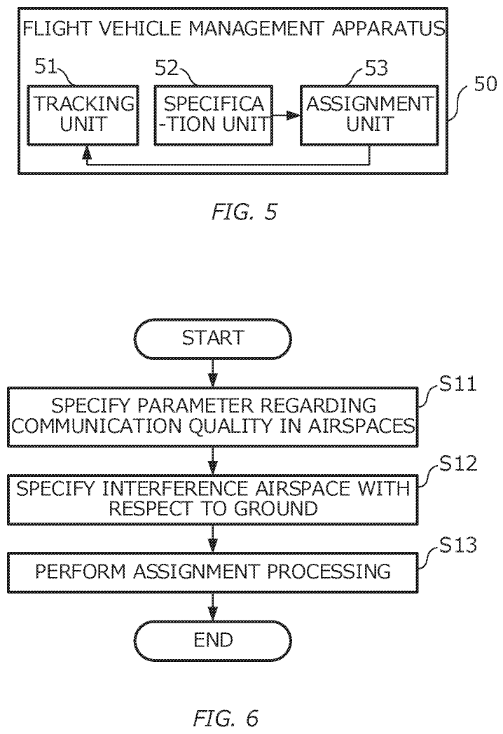

FIG. 3 is a diagram showing the hardware configuration of flight vehicle management apparatus 50. Flight vehicle management apparatus 50 is a computer apparatus that includes CPU 501, ROM 502, RAM 503, auxiliary storage apparatus 504, and communication IF 505. CPU 501 is a processor that performs various types of computation. ROM 502 is a non-volatile memory that stores a program and data used when flight vehicle management apparatus 50 starts up, for example. RAM 503 is a volatile memory that functions as a work area for when CPU 501 executes programs. Auxiliary storage apparatus 504 is a non-volatile storage apparatus such as an HDD or an SSD, and stores programs and data used in flight vehicle management apparatus 50. Later-described functions shown in FIG. 5 are realized by CPU 501 executing such programs. Communication IF 505 is an interface for performing communication via network 90 in compliance with a predetermined communication standard. Note that besides the constituent elements illustrated in FIG. 3, flight vehicle management apparatus 50 may include other constituent elements such as a display unit or an operation unit.

The following describes communication interference that occurs in the radio communication system. As shown in FIG. 4, radio communication apparatus 20a is provided in flight vehicle 10 that flies in the air, and therefore has a good line-of-sight to connection-partner radio base station 40a (solid line arrow), and simultaneously has a good line-of-sight to radio base stations 40b and 40c that are in the vicinity of radio base station 40a (dashed line arrow).

For this reason, in the case of radio communication apparatus 20a, the path loss of the physical downlink channel from radio base station 40a, the path loss of the physical downlink channel from radio base station 40b, and the path loss of the physical downlink channel from radio base station 40c are all small. As a result, signal waves on the physical downlink channels from radio base stations 40a, 40b, and 40c interfere with each other, and non-connection-partner radio base stations 40b and 40c become sources of interference in radio communication apparatus 20a that is connected to radio base station 40a. In other words, signal waves from non-connection-partner radio base stations 40b and 40c become interference waves with respect to signal waves that radio communication apparatus 20a receives from connection-partner radio base station 40a. Accordingly, there is a risk that communication between radio base station 40a and radio communication apparatus 20a will be negatively influenced. In the present embodiment, negative influence caused by such interference is suppressed.

FIG. 5 is a diagram showing an example of the functional configuration of flight vehicle management apparatus 50. Functions of the flight vehicle management apparatus 50 are realized by CPU 501 executing predetermined software (programs) to perform various types of computation, and controlling communication performed by communication IF 505 and the reading and/or writing of data from/to ROM 502, RAM 503, and auxiliary storage apparatus 504.

In FIG. 5, tracking unit 51 stores flight plans, and also records identification information and the flight status of each flight vehicle 10 that is under control of flight vehicle management apparatus 50. The flight status includes positions at which the corresponding flight vehicle 10 is flying, and date/times of such positions. These positions and times are transmitted from radio communication apparatus 20 of flight vehicle 10 to flight vehicle management apparatus 50 along with the identification information of flight vehicle 10 via network 90. Also, tracking unit 51 determines whether or not the position information and the date/time are within the flight plan of the corresponding flight vehicle 10, and, based on the determination result, gives flight instructions to flight vehicle 10 via network 90 as necessary.

For each airspace, specification unit 52 specifies a parameter regarding the communication quality of radio communication apparatuses 20 and 30 in the cell formed by the corresponding radio base station 40 (e.g., the path loss of the physical downlink channel from radio base station 40 to radio communication apparatuses 20 and 30). Each airspace is an airspace that has been defined in advance based on a predetermined reference, for example.

Assignment unit 53 determines flight airspaces that are to be assigned to flight vehicles 10. Specifically, assignment unit 53 performs processing for assigning flight vehicles 10 to airspaces. At this time, assignment unit 53 limits the assignment of flight vehicle 10 to a specified airspace in which the number of radio base stations 40 for which the parameter specified by specification unit 52 is in a predetermined range indicating good communication quality (e.g., the number of radio base stations 40 for which the path loss of the physical downlink channel to radio communication apparatus 20 is less than or equal to a threshold value), is greater than or equal to a predetermined number (e.g., 2). More specifically, if there are multiple radio base stations 40 that have a good line-of-sight to the sky, that is to say, the path loss of the physical downlink channel to radio communication apparatus 20 provided in a certain flight vehicle 10 is less than or equal to a threshold value, then interference such as that shown in FIG. 4 will occur if flight vehicle 10 having radio communication apparatus 20 flies in that airspace. In view of this, assignment unit 53 suppresses such interference in that airspace by limiting the assignment of flight vehicle 10 having radio communication apparatus 20.

The following describes operations in the present embodiment. In FIG. 6, for each airspace, specification unit 52 specifies a parameter regarding the communication quality of radio communication apparatus 20 in the cell formed by the corresponding radio base station 40 (step S11). As previously described, this parameter is the path loss of the physical downlink channel from radio base station 40 to radio communication apparatus 20, for example. As a specific example of a specification method, flight vehicles 10 having radio communication apparatuses 20 are experimentally caused to fly and cover all of the airspaces, such radio communication apparatuses 20 are caused to acquire the path loss of the physical downlink channel in the airspaces, and that information is collected. As another method, a simulation is performed based on the position and size of the cell of each radio base station 40, map information, and a predetermined wave propagation model, and the path loss of the physical downlink channel is measured in each airspace.

Assignment unit 53 specifies an airspace in which the number of radio base stations 40 for which the parameter specified by specification unit 52 is in a predetermined range is a predetermined number or more, as an airspace in which there is a possibility of the interference shown in FIG. 4, which will hereinafter called an interference airspace (step S12). Specifically, assignment unit 53 specifies an airspace in which there are two or more radio base stations 40 for which the path loss of the physical downlink channel to radio communication apparatus 20 of flight vehicle 10 is less than or equal to a threshold value, as an interference airspace.

Then, in accordance with desired flight content that was requested in advance by the operators of flight vehicles 10, for each airspace, assignment unit 53 assigns flight vehicles 10 that are to fly in the airspace, and creates flight plans that include flight paths, flight periods, and the like (step S13). The flight plans are stored in tracking unit 51.

At this time, assignment unit 53 limits the assignment of flight vehicles 10 to the above-described interference airspace. Specifically, assignment unit 53 limits the number of flight vehicles 10 that are assigned to an interference airspace to a greater extent than the number of flight vehicles 10 that are assigned to an airspace other than the interference airspace. For example, assignment unit 53 sets U1 as the upper limit number of flight vehicles 10 that are assigned per unit volume of an interference airspace, and sets U2 as the upper limit number of flight vehicles 10 that are assigned per unit volume of an airspace other than the interference airspace (U1<U2). The minimum value of U1 is 0. Assignment unit 53 assigns flight vehicles 10 to airspaces by writing flight plans to tracking unit 51, in which the identification information of flight vehicles 10 are associated with the identification information of airspaces for flight of such flight vehicles 10 in accordance with the above-described upper limits. Accordingly, there are fewer opportunities for transmission from radio base stations 40b and 40c to radio communication apparatus 20 on the physical downlink channel as shown in FIG. 4, and as a result, the influence of interference is suppressed.

According to the embodiment described above, it is possible to suppress the case where communication performed between radio base station 40 and radio communication apparatus 20 of flight vehicle 10 is negatively influenced in an airspace in which interference occurs due to radio signals from radio base station 40.

Variations

The present invention is not limited to the embodiment described above. The above-described embodiment may be modified as described below. Also, two or more of the following variations may be implemented in combination with each other.

Variation 1

In the case of a radio cell that includes an interference airspace and is formed by, from among a group of radio base stations 40 for which the parameter specified by specification unit 52 is in the predetermined range (e.g., the path loss value of the physical downlink channel is less than or equal to a threshold value, and the predicted interference possibility is high), radio base station 40 that is not radio base station 40 connected to radio communication apparatus 20 provided in flight vehicle 10, assignment unit 53 may relax the limiting of assignment of flight vehicles 10 if the number of, or the communication load of, radio communication apparatuses located in the cell is less than or equal to a threshold value. If the condition that a cell that includes an interference airspace has few or no ground-based radio communication apparatuses 30 located therein, or that the communication load of thereof is low or zero, is satisfied, radio communication apparatus 20 may be assigned to the interference airspace regardless of whether or not it has an interference avoidance function. Such processing corresponds to relaxing the limiting of assignment of flight vehicles 10. Note that a configuration is possible in which consideration is not given to the number of, or the communication load of, radio communication apparatuses 30 that are located in the cell formed by radio base station 40 to which radio communication apparatus 20 provided in flight vehicle 10 is connected.

Also, a configuration is possible in which assignment unit 53 sets a higher number of radio communication apparatuses 20 that are assigned to an interference airspace when the above-described condition is satisfied than when the condition is not satisfied. Also, a configuration is possible in which in the case where the number of, or the communication load of, radio communication apparatuses 30 that are located in a cell that includes an interference airspace is less than or equal to a threshold value, assignment unit 53 eliminates the interference airspace or reduces the size thereof, or raises the threshold value for the path loss in that airspace. Accordingly, the interference airspace will be reduced in size.

Note that assignment unit 53 may detect the situation where the number of, or the communication load of, radio communication apparatuses 30 that are located in a cell that includes an interference airspace is less than or equal to a threshold value, by, similarly to the parameter specification performed by specification unit 52, causing radio communication apparatuses 20 of flight vehicles 10 to acquire the path loss of the physical downlink channel in the corresponding airspaces, and collecting such information, or may detect the aforementioned situation based on the positions and the sizes of the cells of radio base stations 40, as well as map information and a predetermined wave propagation model.

Variation 2

Assignment unit 53 may assign flight vehicle 10 to an interference airspace if radio communication apparatus 20 of flight vehicle 10 has little need to perform communication using the physical downlink channel. This is because if flight vehicle 10 is a flight vehicle that includes a function for autonomously avoiding collisions, or it can be determined based on a flight history or the like that flight vehicle 10 can fly stably for example, then even if radio communication apparatus 20 of flight vehicle 10 suffers interference, that is sometimes not a big problem for the flight of flight vehicle 10 because flight control based on communication performed by radio communication apparatus 20 is not essential. In this way, if radio communication apparatus 20 of flight vehicle 10 has little need to perform communication using the physical downlink channel, assignment unit 53 assigns flight vehicle 10 to an interference airspace. Regarding the determination of whether or not radio communication apparatus 20 has little need to perform communication using the physical downlink channel, it is sufficient that identification information of radio communication apparatus 20 or identification information of flight vehicle 10 that has radio communication apparatus 20 is stored in correspondence with information indicating the degree of need for communication, and that the aforementioned determination is made based on the identification information of radio communication apparatus 20 or the identification information of flight vehicle 10 that has radio communication apparatus 20.

Variation 3

In the present invention, it is sufficient that radio communication apparatus 20 provided in flight vehicle 10 is an apparatus that performs communication that is influenced by interference, that is to say, performs communication using at least a physical downlink channel.

The block diagrams used in the above description of the embodiments shows blocks in units of functions. These functional blocks (configuration units) are realized by any combination of hardware and/or software. Furthermore, there are no particular limitations on the means for realizing the functional blocks. In other words, the functional blocks may be realized by one physically and/or logically combined apparatus, or a plurality of physically and/or logically separated apparatuses that are connected directly and/or indirectly (for example, in a wired and/or wireless manner).

Although the LTE standard is described as an example in the above embodiment, the radio communication standard is not limited to this, and another standard such as 3G or 5G may be used. In other words, the aspects/embodiments described in the present description may be employed to a system that uses LTE(Long Term Evolution), LTE-A(LTE-Advanced), SUPER3G, IMT-Advanced, 4G, 5G, FRA(Future Radio Access), W-CDMA (registered trademark), GSM (registered trademark), CDMA2000, UMB (Ultra Mobile Broadband), IEEE802.11 (Wi-Fi), IEEE802.16 (WiMAX), IEEE802.20, UWB (Ultra-WideBand), or Bluetooth (registered trademark), a system that uses another appropriate system, and/or a next-generation system that is an extension of any of the same.

The orders in the processing procedures, sequences, flowcharts, and the like of the aspects/embodiments described in the present description may be changed as long as no contradictions arise. For example, the methods explained in the present description show various step elements in an exemplified order, and are not limited to the specific order that is shown. The aspects/embodiments described in the present description may also be used alone or in combination, or may also be switched when they are implemented. Furthermore, the notification of predetermined information (e.g., notification of “being X”) is not limited to being performed explicitly, and may also be performed implicitly (for example, notification of the predetermined information is not performed).

The terms “system” and “network” used in the present description can be used in an interchangeable manner.

The information and the parameters described in the present description may also be expressed by absolute values, relative values with respect to a predetermined value, or another type of corresponding information. For example, a radio resource may also be one indicated by an index.

The names used for the above-described parameters are in no way limiting. Furthermore, there may be a case where formulae and the like using these parameters are different from those explicitly disclosed in the present description. Various channels (such as, for example, a PUCCH and a PDCCH) and information elements (such as, for example, a TPC) can be identified by any suitable name, and thus various names assigned to these various channels and information elements are no way limiting. For example, an example was described in which the function of the radio communication apparatus for controlling the transmit power is realized with use of an LTE channel, message, or parameter, but this function can be realized using a 3G or 5G equivalent channel, message, or parameter.

The term “determining” used in the present description may include various types of operations. The term “determining” can include a case where judging, calculating, computing, processing, deriving, investigating, looking up (for example, looking up a table, a data base, or another data structure), or ascertaining is regarded as “determining”. Furthermore, the term “determining” can include a case where receiving (for example, receiving information), transmitting (for example, transmitting information), inputting, outputting, or accessing (for example, accessing data in the memory) is regarded as “determining”. Furthermore, the term “determining” can include a case where resolving, selecting, choosing, establishing, or comparing is regarded as “determining”. In other words, the term “determining” can include a case where some operation is regarded as “determining”.

The present invention may be provided as a flight control method that includes the processing steps performed in flight control system 1 or flight vehicle management apparatus 50. Also, the present invention may be provided as a program for execution in flight vehicle 10 or flight vehicle management apparatus 50. This program may be provided in an aspect of being recorded on a recording medium such as an optical disk, or may be provided in an aspect of being downloaded to a computer via a network such as the Internet and being installed in the computer to become usable, for example.

Software, instructions, and the like may also be transmitted/received via a transmission medium. For example, if software is transmitted from a web site, a server, or another remote source using a wired technology such as a coaxial cable, an optical fiber cable, a twisted-pair wire, or a digital subscriber line (DSL), and/or a wireless technology using infrared light, radio waves, microwaves, or the like, the definition of the transmission medium will include the wired technology and/or the wireless technology.

Information, signals, and the like described in the present description may also be expressed using any of various different technologies. For example, data, an instruction, a command, information, a signal, a bit, a symbol, a chip, and the like that may be mentioned throughout the entire description above may also be expressed by an electric voltage, an electric current, an electromagnetic wave, a magnetic field or a magnetic particle, an optical field or a photon, or an arbitrary combination thereof.

Note that the terms described in the present description and/or the terms needed for understanding the present description may also be replaced by terms that have the same or similar meaning. For example, a channel and/or a symbol may also be a signal. Furthermore, a signal may also be a message. Furthermore, a component carrier (CC) may also be referred to as a carrier frequency, a cell, or the like.

All references to elements that have been given names such as “first” and “second” in the present description do not overall limit the number of such elements or the orders thereof. Such names may be used in the present description as a convenient method for distinguishing between two or more elements. Accordingly, references to first and second elements are not intended to mean that only two elements can be employed, or that the first element is required to come before the second element in some sort of manner.

The “means” in the configurations of the above-described apparatuses may be replaced by “unit”, “circuit”, “device”, or the like.

The terms “including”, “comprising”, and other forms thereof are intended to be comprehensive as long as they are used in the present description or the claims, similar to the term “being provided with”. Furthermore, the term “or” used in the present description or the claims is intended not to be exclusive OR.

In the entirety of the present disclosure, when articles are added through translation, for example, as “a”, “an”, and “the” in English, these articles also denote the plural form unless it is clear otherwise from the context.

While the present invention has been described in detail, it would be obvious to those skilled in the art that the present invention is not limited to the embodiments explained in the present description. The present invention can be implemented as corrected and modified aspects without departing from the spirit and scope of the present invention that are defined by the description of the claims. Accordingly, the present description aims to illustrate examples and is not intended to restrict the present invention in any way.

### REFERENCE SIGNS LIST

1. flight control system

10. flight vehicle

20, 30. radio communication apparatus

201. CPU

202. ROM

203. RAM

204. auxiliary storage apparatus

205. communication IF

50. flight vehicle management apparatus

51. tracking unit

52. specification unit

53. assignment unit

501. CPU

502. ROM

503. RAM

504. auxiliary storage apparatus

505. communication IF

1.-4. (canceled)

5. A flight vehicle management apparatus comprising:
a specification unit configured to specify, for each airspace, a parameter regarding a communication quality of a radio communication apparatus in a cell formed by a radio base station; and
an assignment unit configured to, for each airspace, assign a flight vehicle having a radio communication apparatus that performs communication using at least a physical downlink channel as a flight vehicle that is to fly in the airspace, and to limit assignment of a flight vehicle to an interference airspace, the interference airspace being an airspace in which the number of radio base stations for which the parameter specified by the specification unit is in a predetermined range is greater than or equal to a predetermined number.

6. The flight vehicle management apparatus according to claim 5,
wherein in a case of a radio cell that is formed by, from among a group of radio base stations for which the parameter specified by specification unit is in the predetermined range, a radio base station that is not a radio base station connected to a radio communication apparatus provided in a flight vehicle, the assignment unit relaxes the limiting of assignment of a flight vehicle or reduces the size of the interference airspace if the number of, or a communication load of, other radio communication apparatuses located in the radio cell is less than or equal to a threshold value.

7. The flight vehicle management apparatus according to claim 6,
wherein in a case of relaxing the limiting, the assignment unit assigns a larger number of flight vehicles to the interference airspace than in a case of not relaxing the limiting.

8. The flight vehicle management apparatus according to claim 5,
wherein in a case where a radio communication apparatus of a flight vehicle has little need to perform communication using a physical downlink channel, the assignment unit assigns the flight vehicle to the interference airspace.
